(19) United States
(12) Patent Application Publication
(10) Pub. No.: US 2020/0129987 A1
(43) Pub. Date: Apr. 30, 2020

(54) ROTOR OF A WASTE MILLING MACHINE

(71) Applicant: CAMEC S.R.L., Cittadella (IT)

(72) Inventor: Eddy CANDIOTTO, Villa Del Conte (IT)

(21) Appl. No.: 16/667,267

(22) Filed: Oct. 29, 2019

(30) Foreign Application Priority Data
Oct. 30, 2018 (IT) 102018000009878

(51) Int. Cl. B02C 18/00; B02C 18/18

(52) U.S. Cl. CPC B02C 18/0092; B02C 18/18

(57) ABSTRACT

A rotor of a waste milling machine includes several tooth-shaped cutters distributed on the rotor surface and several circular sector-shaped annular portions which are installed reversibly on the rotor surface. In a same circular portion of the rotor, the annular portions are alternated with the tooth-shaped cutters and protrude outward less than the top of the latter.

### CROSS-REFERENCE TO RELATED APPLICATIONS

This application claims priority to Italian Patent Application No. 102018000009878, filed on Oct. 30, 2018, the contents of which are hereby incorporated by reference in their entirety.

### TECHNICAL FIELD

The present disclosure relates to a rotor of a waste milling machine.

The rotor has application in machines used in the milling of production discards, selected waste, plastic purges, cardboard, wood, copper cables, plastic material and, in particular, in the milling of waste made of plastic material that has a particular resistance to being broken up.

The above machines have a supporting frame on which a milling rotor is mounted in a milling chamber, and is rotated by a special motor and provided with a plurality of cutters fixed reversibly thereto which are adapted to pass during the rotation of the rotor between cutters that are fixed to the frame. The number of cutters determines the capacity of the machine to mill waste.

Above the milling chamber is a hopper for loading the waste, which is associated with the upper part of the frame.

Also in the upper part of the frame, above the milling chamber, is a pusher which is adapted to push the loaded waste against the rotor.

To push the waste against the rotor, the use is widespread of radial pushers and linear pushers.

### BACKGROUND

Waste made of plastic material, like large-sized containers, or mixed-plastic waste from separate waste collection, or large-sized molded plastic agglomerates of industrial discards, must be reduced to a size range that can be recycled.

This process currently requires the use of multiple machines which gradually reduce the size range of the waste at each stage from one machine to the subsequent one, until the waste reaches the desired size.

Large-sized molded plastic agglomerates with high mechanical resistance to being broken up often have fiberglass added in the mixing step in order to increase its impact resistance.

Some examples of use of these plastics are found in the automotive sector (car fenders, fuel tanks, dashboards, wheelhouses).

Discards made of plastic material are also resistant to being broken up, as are, in particular, purges from machines for processing plastic material.

Often, mills use a hydraulic motor to drive the milling rotor. To reach the high torque levels required for milling waste like that described above, the motor must be of adequate cubic capacity with consequent adequate dimensioning of the electric motor that actuates the hydraulic pump.

Furthermore, nowadays materials are processed that have different hardnesses, forms and textures, such as wood, plastic of varying hardness, cardboard, copper wires, etc. It can therefore happen that, during the useful life of the machine, the need arises to process materials that were not envisaged at the design stage.

The mills used nowadays are in fact designed to process only one specific type of material, therefore they are dedicated machines for processing materials of a certain texture, hardness and form.

Therefore the need is felt to develop versatile machines, which can be adapted to the different materials to be processed.

For the purpose of meeting this need, makers typically offer machines with interchangeable rotors. This solution is obviously effective, but it is also very expensive, however, because it requires the purchase of a great many rotors.

However, considering that the space available in the modern plants is increasingly reduced, it is therefore necessary to design machines that are versatile and, at the same time, compact and easy to move, without necessarily having to dismantle them, at least partially, for transport and without requiring a plurality of cumbersome rotors for the different materials to be processed.

By contrast, in traditional mills the linear pusher needs to be removed for transport, owing to encumbrances which exceed the legal limits. This operation, in addition to being expensive, also requires the use and availability of special tools at the end customer site.

### SUMMARY

The aim of the present disclosure is to provide a machine and a rotor that are capable of improving the known art in one or more of the above mentioned aspects.

Within this aim, the disclosure provides a machine and a rotor for that machine, by virtue of which it is possible to mill a great many different materials, at low cost.

The disclosure also provides a machine that is compact but with high performance in milling the various different materials.

Furthermore, the present disclosure overcomes the drawbacks of the known art in an alternative manner to any existing solutions.

The disclosure also provides a machine and a rotor that are highly reliable, easy to implement and of low cost.

This aim and these and other advantages which will become better apparent hereinafter are achieved by providing a rotor of a waste milling machine, provided with a plurality of tooth-shaped cutters distributed on its surface and characterized in that it has a plurality of circular sector-shaped annular portions which are installed reversibly thereon, and in that in a same circular portion of said rotor said annular portions are alternated with said tooth-shaped cutters and protrude outward less than the top of the latter.

### BRIEF DESCRIPTION OF THE DRAWINGS

Further characteristics and advantages of the disclosure will become better apparent from the detailed description that follows of a preferred, but not exclusive, embodiment of the rotor according to the disclosure, which is illustrated by way of non-limiting example in the accompanying drawings wherein:

FIG. 1 is a partially exploded perspective view of the rotor according to the disclosure;

FIG. 2 is an enlarged front elevation view of a part of the rotor; and

FIG. 3 is a cross-sectional view, taken on a vertical plane, of a machine fitted with a rotor according to the disclosure.

### DETAILED DESCRIPTION OF THE DRAWINGS

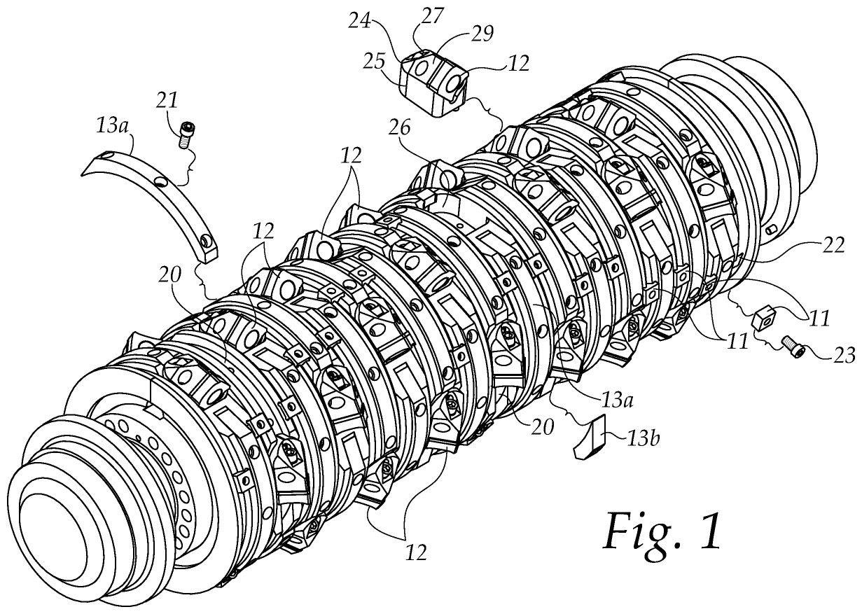

With reference to FIGS. 1-3, the rotor according to the disclosure, generally designated by the reference numeral 10, has a plurality of tooth-shaped cutters 12 distributed on its surface and, in the example shown, also has a plurality of blade-shaped cutters 11, also distributed on its surface.

Advantageously, the rotor 10 is further provided with a plurality of circular sector-shaped annular portions 13 which are installed reversibly thereon, and in a same circular portion of the rotor 10 the annular portions are alternated with the tooth-shaped cutters 12 and protrude outward less than the top of the latter.

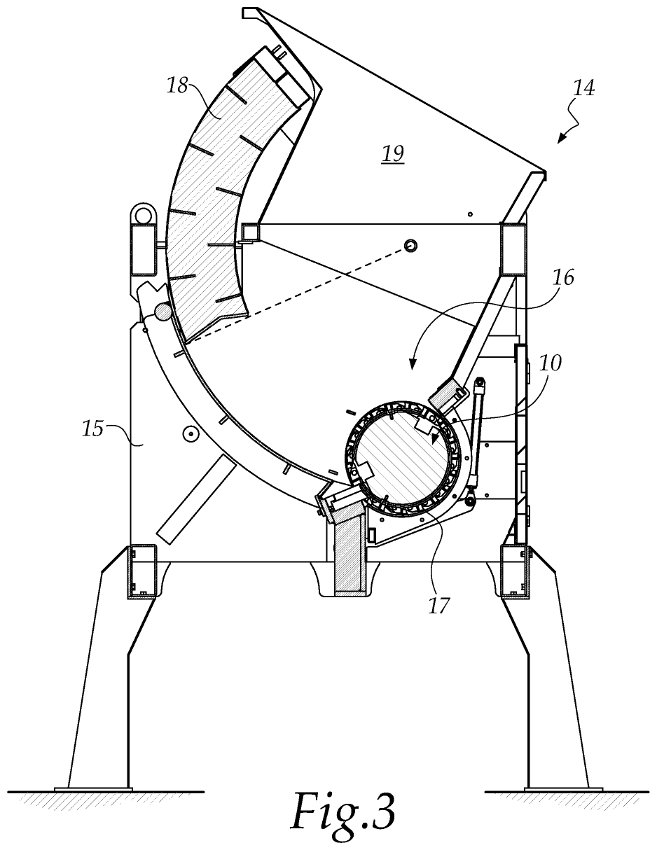

The rotor 10 is mounted with a horizontal rotation axis inside a milling machine 14, shown in FIG. 3. The machine 14 is provided with:
a supporting frame 15,
a milling chamber 16 in which the rotor 10 is mounted,
a redirecting screen 17 below the rotor 10 (with openings for the passage of the milled material, which are not visible in the illustration of the machine, in order to simplify its content),
a pusher 18, substantially arc-shaped in cross-section, designed to push the material inserted into the milling chamber 16 from above against the rotor 10,
a hopper 19 above the milling chamber 16 for loading the waste from above.

The machine also conveniently comprises means for movement of the pusher 18, not shown in the accompanying figures, but of conventional type, which comprise, on each one of the opposite sides, cylinder actuators which are adapted to make it rotate.

The actuators are actuated by a hydraulic pump, which is advantageously provided with a motor commanded by an inverter.

As shown in FIG. 1, the annular portions 13 are of different lengths, as a function of the distance between two successive tooth-shaped cutters 12 installed on the same circular portion.

The thickness of the portions 13 depends on the material to be processed in the machine and, as a function of that thickness, the annular portions 13 describe, during rotation of the rotor 10 about its own rotation axis, circumferences of a corresponding diameter, but always smaller than the diameter of the circumferences described by the top of the tooth-shaped cutters 12.

The annular portions 13 are arranged in respective fixing seats 20 and are fixed to the rotor 10 by way of fixing screws 21 which are inserted radially into the rotor 10.

The blade-shaped cutters 11 and tooth-shaped cutters 12 are constituted by plates installed on the rotor 10 in a conventional manner.

The blade-shaped cutters 11 are installed at the sides of respective annular portions 13, each one in a respective cutter supporting seat 22 and fixed to the rotor by way of an fixing screw 23 which is inserted in a radial direction into the rotor 10 and at right angles to a face of the plate that constitutes the blade-shaped cutter 11.

Such cutters 11 can be arranged in an ordered manner along the rotor 19, for example in pairs across a portion of ring 13 and according to a dextrorotatory or levorotatory helical path.

The tooth-shaped cutters 12 are also arranged in an ordered manner along the rotor 10, for example, like the previously mentioned cutters, according to a dextrorotatory or levorotatory helical path.

Each one of the tooth-shaped cutters 12 is fixed to the rotor 10 in a conventional manner by way of a supporting block 24 with a portion 25 for insertion into a corresponding locking seat 26 which is defined on the rotor 10, and a cutter supporting portion 29, which extends from the portion for insertion 25 toward the outside of the rotor 10 and has a through hole, in a direction substantially tangential to the rotor 10, for a screw 27 for fixing a plate that constitutes the tooth-shaped cutter 12.

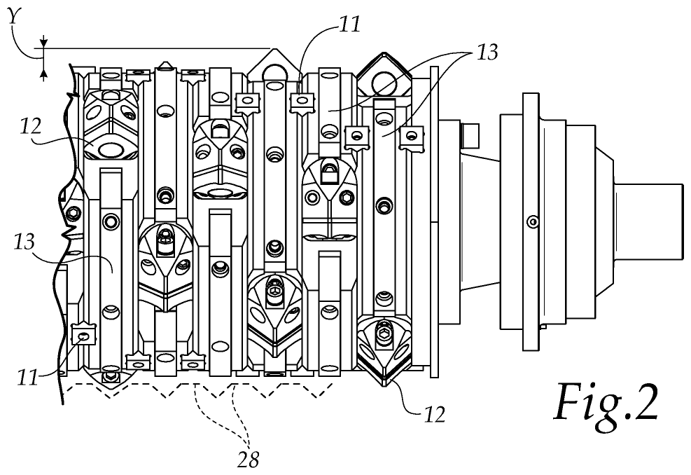

The tooth-shaped cutters 12, installed using the supporting block 24, protrude from the rotor 10 with respective triangular portions (the plates being rectangular and arranged with one corner toward the outside of the rotor), in order to execute the milling operations, crossing tooth cutters 28 which are integral with the frame of the machine (and indicated in FIG. 2).

The thickness of the annular portions 13 determines the difference in height with the tips of the second plates 12, which must be compatible with the material being processed in order to prevent the cutter plates from being subjected to strains that are such as to cause damage or early wear. The difference in height is shown in the enlargement in FIG. 2 and indicated with the reference letter Y.

A greater outside diameter of the sectors, therefore a greater height and a smaller difference from the tips of the cutters 12, further reduces the size range of the processed material and reduces the frequency of inversions of the rotor, preserving the machine from excessive impacts, but with reduced productivity.

A smaller outside diameter increases the size range of the processed material but induces more intense impacts, thus increasing the frequency of inversions, which in turn determines a reduction in productivity.

The optimal outside diameter of the annular portions 13, i.e. the diameter that enables the best productivity, must be determined as a fair compromise between the different factors in play and as a function of the type of material.

The dimensioning of the annular portions must be based on the following parameters: the width, the inclination proximate to the cutter, the depth of the sector-holder, and the outside diameter.

In FIG. 1 note that the portions 13 advantageously have an inclination proximate to the tooth-shaped cutters 12, in order not to prevent the passage of material toward the cutting parts and not limit the cutting capacity.

Use of the rotor, according to the disclosure, is the following.

The annular portions 13 are substituted with portions of thickness that is deemed optimal on the basis of the material to be processed.

The substitution occurs simply by removing the portions 13 and fixing others, by way of fixing with the screws 21.

When the waste is introduced into the machine from above through the hopper 19 into the milling chamber 16, the pusher 18 is moved vertically in order to push the material against the rotor 10.

The presence of different cutting tools, i.e. the blade-shaped cutters 11 and the tooth-shaped cutters 12, and their arrangement, make it possible to provide a substantially continuous cutting profile at each revolution of the rotor 10.

Under the rotor 10 is the redirecting screen, with a cross-section shaped like a circular arc, which does not allow the material to pass through its openings until it has reached a size smaller than its openings.

The machine 10, by virtue of the pusher, the redirecting screen, the cutters and the annular portions, makes the material recirculate until it reaches the necessary size for it to pass through.

The force exerted by the pusher is controlled dynamically, i.e. during use of the machine, in order to limit machine stops and the number of inversions of the rotor.

The use of annular portions of optimal dimensions for the material to be processed makes it possible to reduce the frequency of inversions of the rotor and, in combination with the dynamic adjustment of the force exerted by the pusher, to maximize productivity.

Dynamic control is obtained by providing the hydraulic pump that actuates the cylinder of the pusher with a motor controlled by an inverter.

By dynamically managing the pressure of the pusher, consequently the power absorbed by the mill is managed in the same way, in order to maximize its performance at all times.

Managing the pusher with an inverter gives the additional benefit of being able to manage the speed during the entire travel, the stops and the restarts, which otherwise would be very sudden, producing major impacts and noise.

It should be noted that thanks to the presence of a radial pusher and without the aid of further pushers, the machine is compact in size and therefore easy to move, while not being limited in performance, by virtue of the dynamic adjustment of the pusher and the use of a rotor with optimal structural characteristics for the type of materials processed.

Any wear of the pusher is due solely to contact with the materials processed.

It should also be noted how simply the annular portions can be removed from and mounted on the rotor, by virtue of the fixing by way of screws, which make possible a fixing that is long-lasting and stable over time. Furthermore, worn portions can be just as easily replaced.

Furthermore, it is fundamental that the annular portions limit the space between them and the cutters that are integral with the frame, with which they cross during the rotation of the rotor.

Particularly hard materials can result in high forces at the interface with the tooth-shaped cutters and therefore subject the rotor and the machine to intense and damaging impacts. The dynamic adjustment of the pusher and the right space between cutters limits the occurrence of impacts.

In practice it has been found that the disclosure fully achieves the intended aim and advantages by providing a rotor that is capable of making it possible, with a same machine, with limited space occupation, to mill a great many different materials, with simple interventions and at low cost.

The disclosure thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

1. A rotor of a waste milling machine, the rotor comprising: a plurality of tooth-shaped cutters distributed on a surface of the rotor, wherein the rotor further includes a plurality of circular sector-shaped annular portions installed reversibly on the rotor, and wherein in a same circular portion of said rotor, said annular portions are alternated with said tooth-shaped cutters and protrude outward less than the top of the latter.

2. The rotor according to claim 1, wherein each of said annular portions is installed in a corresponding fixing seat by way of at least one fixing screw inserted radially into the rotor.

3. The rotor according to claim 1, wherein the rotor is provided with a plurality of blade-shaped cutters distributed on the surface.

4. The rotor according to claim 3, wherein said blade-shaped cutters are installed at the sides of said annular portions.

5. The rotor according to claim 3, wherein each one of said blade-shaped cutters is installed in a respective cutter supporting seat and is fixed to said rotor by way of a fixing screw which is inserted in a radial direction into said rotor and at right angles to a face of the same plate that constitutes said blade-shaped cutter.

6. The rotor according to claim 1, wherein each one of said tooth-shaped cutters is fixed to the rotor by way of a supporting block with a portion for insertion into a corresponding locking seat defined on the rotor and a cutter supporting portion, which extends from the portion for insertion toward the outside of the rotor and has a through hole in a direction substantially tangential to said rotor configured for receiving a screw for fixing a plate that constitutes said tooth-shaped cutter.
